(19) United States
(12) Patent Application Publication
(10) Pub. No.: US 2022/0149425 A1
(43) Pub. Date: May 12, 2022

(54) NONAQUEOUS ELECTROLYTE FOR LITHIUM ION SECONDARY BATTERY, AND LITHIUM ION SECONDARY BATTERY CONTAINING THE SAME

(71) Applicant: EoCell Limited, Hong Kong (CN)

(72) Inventor: Young Sam PARK, Los Gatos, CA (US)

(21) Appl. No.: 17/092,266

(22) Filed: Nov. 7, 2020

(51) Int. Cl. H01M 10/0525; H01M 10/0567; H01M 10/0569; H01M 10/0568; H01M 4/583; H01M 4/525; H01M 4/505

(52) U.S. Cl. CPC H01M 10/0525; H01M 10/0567; H01M 10/0569; H01M 2300/0037; H01M 4/583; H01M 4/525; H01M 4/505; H01M 10/0568

(57) ABSTRACT

A multi-additive electrolyte composition for a lithium ion secondary battery includes a lithium salt; at least one organic solvent; and a combination of additives including each of: vinylene carbonate (VC), fluoroethylene carbonate (FEC), lithium diflurobis(oxalate)phosphate (LiDFBP), and adiponitrile (ADN), e.g., wherein VC is present at 0.5 to 5%; FEC is present at 1 to 10%; LiDFBP is present at 0.5 to 5%; and ADN is present at 0.3 to 3% by weight, based on total electrolyte composition weight. A lithium ion secondary battery includes a positive electrode having an active cathode material including a nickel-cobalt-manganese composition; a negative electrode having an active anode material including silicon and graphite; a separator interposed between the positive electrode and the negative electrode; and the aforementioned multi-additive electrolyte composition. A large electric vehicle (EV) 48 Ah cell using such a multi-additive electrolyte composition achieved 80% capacity retention at 1,511 cycles.

### TECHNICAL FIELD

Aspects of the present disclosure relate to electrolyte compositions, formulations, or solutions including combinations of particular additives that greatly improve cycle life and high temperature stability for cell chemistries involving (a) high-nickel nickel-cobalt-manganese (NCM) cathode, and (b) anode blended with silicon and artificial or natural graphite in lithium ion secondary battery cells; and lithium ion secondary battery cells including the same.

### BACKGROUND

Li ion secondary batteries have been used as power sources for consumer electronics and electric vehicles (EV) due to their high energy density. Recently, because of demands for environmentally-friendly energy, research on new energy sources is intensively being carried out. In particular, as power sources of electrified vehicles such as EV, plug-in hybrid electric vehicles (PHEV), and hybrid electric vehicles (HEV), research and development on lithium secondary batteries that provide high energy density is actively being performed.

In order to improve cell energy density, a lithium secondary battery cell chemistry has been developed that utilizes (a) Ni-rich nickel-cobalt-manganese (NCM) cathode, which can also be referred to as Nickel Manganese Cobalt Oxide (NCM) cathode; and (b) Si blended graphite anode. The specific capacity of NCM as a function of Ni content substantially improves with increasing Ni content, and thus Ni enrichment of the NCM cathode tends to enhance cell energy density and power capability accordingly due to increasing electrical conductivity. However, electrolyte is reactive to the Ni species of high-Ni NCM, causing irreversible reaction(s) on the cathode and undesirably producing gas products. More specifically, in a highly delithiated state, high-Ni NCM tends to generate large amounts of Ni⁴⁺ that can react with electrolyte. This side reaction significantly thickens the cathode/electrolyte interface(s) and reduces the available Li ion source, thus increasing resistance. The Ni⁴⁺ species cause increased evolution of gas products at upper cutoff voltages, relative to which cathodes with higher Ni content suffer from more parasitic reactions with Ni species. An NCM based cathode with Ni-rich surfaces behaves differently than other cathodes with different lower proportions of Ni.

An additional problem that arises is the dissolution of transition metal components of the NCM cathode, which results in capacity attenuation because it can decrease Li⁺ insertion sites. Another issue arising from such NCM dissolution involves in the production of resistive fluorinated transition metals as a side product on the surface of the NCM. Moreover, the dissolution of transition metals even poses a problem to the anode through electrodeposition catalyzing electrolyte reduction and the formation of inorganic layers in the solid electrolyte interphase (SEI), all of which can impede Li⁺ intercalation and fade cell performance.

Certain cathode additives have been used in an attempt to stabilize the Ni-rich surface of NCM and prevent the dissolution of NCM transition metals. However, NCM stabilization by way of cathode additives remains inadequate, insufficient, or ineffective to date.

To achieve high energy density lithium ion secondary batteries, silicon material is used for the anode because of its high gravimetric and volumetric capacity. However, Si anodes, as one of the major components of cell chemistry for high energy density, have shown very poor cycling performance. The main reason for their poor cycling performance is ascribed to their very large volume change during cycling, which increases internal resistance and loss of contact area. The very large change in volume affects SEI stability at the interface between the Si and the electrolyte, and consequently the SEI keeps breaking down and reforming during cycling. The resulting thick SEI layer is harmful for cycle life, and causes a rise of electrode impedance and polarization. This intrinsic problem associated with the Si material cannot be avoided, and a need exists for mitigating or significantly mitigating this problem.

### SUMMARY

In accordance with an aspect of the present disclosure, a multi-additive lithium ion secondary battery electrolyte formulation or composition includes or consists essentially of:

a lithium salt (for instance, in various embodiments LiPF₆, in a concentration range of approximately 1 to 1.6M, e.g., approximately 1.15M);
at least one organic solvent or solvent system (for instance, a ternary solvent system such as ethylene carbonate (EC)/ethylmethyl carbonate (EMC)/dimethyl carbonate (DMC) in a ratio of approximately 3/4/3, in a manner readily understood by individuals having ordinary skill in the relevant art); and
a plurality of additives, or a multi-component additive formulation or composition, comprising or consisting essentially of:
vinylene carbonate (VC) having structure (i):

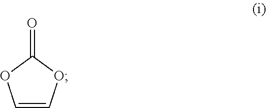

fluoroethylene carbonate (FEC) having structure (ii):

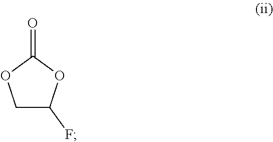

lithium diflurobis(oxalate)phosphate (LiDFBP) having chemical formula (1) and structure (iii):

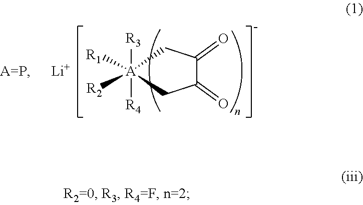

and
adiponitrile (ADN) having chemical formula (2) and structure (iv):

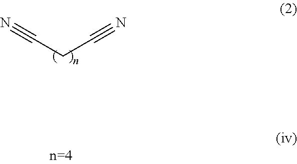

in combination.

In such an electrolyte composition, the VC can be present at 0.5 to 5% by weight based on total weight of the electrolyte composition. More particularly, the VC can be present at 1 to 3% by weight based on total weight of the electrolyte composition.

In such an electrolyte composition, the FEC can be present at 1 to 10% by weight based on total weight of the electrolyte composition. More particularly, depending upon embodiment details the FEC can be present at 2%, 2.5%, or 3% to 8%, 8.5%, 9%, or 9.5% by weight based on total weight of the electrolyte composition (e.g., 3% to 8% in multiple embodiments). It should be noted that in various embodiments, the FEC is present at no greater than 10% by weight based on total weight of the electrolyte composition, or the FEC is present at less than or equal to 8%, 8.5%, 9%, or 9.5% (but typically at least 2%, 2.5%, or 3%) by weight based on total weight of the electrolyte composition. Limiting the FEC in such a manner, for instance, to no greater than 10% by weight based on the total weight of the electrolyte composition, can mitigate adverse effects associated with high(er) FEC contents, as the presence of FEC at greater than 10% by weight based on the total weight of the electrolyte composition can cause significant adverse effects.

In such an electrolyte composition, the LiDFBP can be present at 0.5 to 5% by weight based on total weight of the electrolyte composition. More particularly, the LiDFBP can be present at 0.5 to 3% by weight based on total weight of the electrolyte composition.

In such an electrolyte composition, the ADN can be present at 0.3 to 3% by weight based on total weight of the electrolyte composition. More particularly, depending upon embodiment details the ADN can be present at 0.3 to 2% by weight based on total weight of the electrolyte composition. It can be noted that ADN is typically associated with undesirably high resistance, even in situations in which ADN is used for protecting the cathode surface. As a result, ADN has not previously been utilized in electric vehicle (EV), plug-in hybrid EV (PHEV), or hybrid EV (HEV) applications. However, as further detailed below, in electrolyte compositions or formulations in accordance with various embodiments of the present disclosure, the use of a unique multi-additive formulation or composition achieves low resistance even though the multi-additive formulation or composition includes ADN.

In accordance with another aspect of the present disclosure, a lithium ion secondary battery includes or consists essentially of: a positive electrode having an active cathode material including a nickel-cobalt-manganese composition; a negative electrode having an active anode material including silicon and graphite; a separator interposed between the positive electrode and the negative electrode; and a multi-additive electrolyte composition having each of the plurality of additives VC, FEC, LiDFBP, and ADN in combination as set forth above/herein.

In such a lithium ion secondary battery, the nickel-cobalt-manganese composition can be Li(Niₐ Co_{b} Mn_{c})O₂, where 0.7<a<0.95, 0.025<b<0.15, 0.025<c<0.15, and a+b+c=1.

In such a lithium ion secondary battery, the active anode material can include or be artificial graphite blended with silicon in the form of silicon oxide (SiOx) or silicon carbon nanocomposite (SCN). In such a lithium ion secondary battery, the pure silicon content of the SiOx or the SCN can fall within the range 1≤Si≤7%.

### BRIEF DESCRIPTION OF THE DRAWINGS

FIG. 1 is a graph showing cycling test results for 2.1 Amp-hour (Ah) pouch cells, including cycling test results for representative example lithium ion secondary batteries including electrolyte compositions (UE-064) in accordance with embodiments of the present disclosure, and cycling test results for control lithium ion secondary batteries using a control electrolyte (Control-ELY).

FIG. 2 is a graph showing cycle life test results for a large electric vehicle (EV) 48 Ah cell using an electrolyte composition (UE-064) in accordance with an embodiment of the present disclosure, which achieved 80% capacity retention at 1,511 cycles.

FIG. 3 is a graph showing direct current resistance (DCR) results for 2.1 Ah surrogate cells corresponding to representative example lithium ion secondary batteries having electrolyte compositions (UE-064) in accordance with embodiments of the present disclosure, and also corresponding to control lithium ion secondary batteries having a control electrolyte (Control-ELY).

FIG. 4 is a graph showing rate capability results for 2.1 Ah surrogate cells corresponding to representative example lithium ion secondary batteries having electrolyte compositions (UE-064) in accordance with embodiments of the present disclosure, and also corresponding to control lithium ion secondary batteries having a control electrolyte (Control-ELY).

FIGS. 5A and 5B are graphs showing 55° Celsius (° C.) storage test results including capacity recovery results (FIG. 5A) and direct current internal resistance (DCIR) increasing rate results (FIG. 5B) corresponding to representative example lithium ion secondary batteries having electrolyte compositions (UE-064) in accordance with embodiments of the present disclosure.

FIGS. 6A and 6B are graphs showing 55° C. storage test results including capacity recovery results (FIG. 6A) and direct current internal resistance (DCIR) increasing rate results (FIG. 6B) corresponding to control lithium ion secondary batteries having a control electrolyte (Control-ELY).

FIG. 7 is a graph showing Electrical Impedance Spectroscopy results corresponding to particular electrolyte additives by themselves, as well as an electrolyte additive combination in accordance with an embodiment of the present disclosure.

### DETAILED DESCRIPTION

### Further Aspects of the Technical Problem

A lithium secondary battery includes a non-aqueous electrolyte which is composed of lithium salts, organic solvents, and functional additives. The organic solvents require high dielectric constant to dissolve lithium salt to sufficient concentration, and low viscosity to facilitate mobility of lithium ions. In order to fulfill these requirements, cyclic carbonates such ethylene carbonate and propylene carbonate for high dielectric constant and linear carbonates such as ethyl methyl carbonate, dimethyl carbonate and diethyl carbonate for ionic mobility are used. Because high dielectric constant and low viscosity usually cannot be integrated into a single solvent, a solvent mixture, usually a binary or ternary solvent system, with one of the components selected for dielectric constant and others for ionic mobility, is used to formulate electrolytes for lithium secondary batteries.

The chemical constituents or components of electrolytes affect cell performance in many respects, including cycle life, rate capacity, safety, etc. . . . . Recently, the choice of electrolyte components has been dictated by the electrode materials used in order to optimize battery performance. Thus, current electrolyte systems in lithium secondary batteries are tailor-made for a specific cell chemistry, relative to which the electrolyte components are subjected to surface chemistries on the cathode and the anode under electrochemical conditions while performing the reversible shuttling of lithium ions between cathode and anode. In this respect, the use of electrolyte additives can significantly change the properties of the electrolyte, such that the complete replacement of one or more major components of the current electrolyte system(s) that cause problems or which may be associated with unsatisfactory performance can be avoided.

Nickel-based transition metal oxides, e.g., nickel-cobalt-manganese (NCM), have been used in cathodes due to their capacity characteristics. The specific capacity of NCM improves with increasing Ni content, thus Ni-rich NCM can enhance cell energy density. However, due to the high reactivity between the Ni species and the electrolyte, cycle performance rapidly deteriorates when high Ni component content is used, as side reactions between cathode and electrolyte cause capacity loss and initial cycle inefficiency, and produce excessive gas products leading to cell bulging. This problem becomes much more severe at high temperature.

With the use of Ni-rich NCM in a lithium secondary battery's cathode to achieve high energy density, an anode of high specific capacity needs to be employed to match the high specific capacity delivered from the cathode, and enable the use of a thinner anode. A Si anode has the highest specific capacity, but its cycling performance is very poor. The fading mechanism of Si anodes is well known. The large change in the volume of Si anodes is the main reason for their rapid capacity decay, by increasing resistance and loss of contact area between silicon and conductive materials. As the result of volume change, Si particles experience pulverization during cycling. This problem destabilizes the solid electrolyte interphase (SEI) layer on the surface of anodes having Si included therein. The SEI layer is significantly formed during the first cycle, specifically the charging process. The thin layer of SEI is in an expanded state during lithiation, then the silicon material shrinks during delithiation. Repeated processes of lithiation and delithiation make the SEI break, and the resulting fresh silicon surface is exposed to the electrolyte. New SEI is continuously formed on the newly exposed silicon surfaces. The growth of SEI is terminated at a certain thickness and electrolyte is also depleted by the continuous reactions, stopping transport of lithium ions between cathode and anode. The thick SEI raises impedance and decreases electrode electrochemical activity. Such large volume change and repeated breakage or destruction of the SEI layer are the main causes for the failure of Si anodes.

Tremendous efforts have been undertaken to overcome the problems associated with the use of silicon material in anodes. However, improvements have been limited, and the unique properties of silicon material described above cannot be completely eliminated.

In prior attempts to solve problems such as capacity decay, poor cycle life, and instability of cell chemistry, especially at high temperature, vinyl carbonate (VC), vinyl ethylene carbonate (VEC) and the like, which are known as electrolyte additives for forming SEI films, have been used. However, conventional electrolyte compositions or formulations including those additives are not effective for improvement of the cell chemistries involving (a) Ni-rich NCM cathode, and (b) silicon containing anode.

Fluoroethylene carbonate (FEC) is known to have an impact on the performance of Si anodes, and has been used in amounts of 15˜20% by weight, or even in excess thereof, as an electrolyte solvent in conventional electrolyte formulations. However, a serious problem with such amounts of FEC is the generation of an undesirable acid component, hydrofluoric acid (HF), as a byproduct in the reaction mechanism, which acts as a catalyst in organic or electrochemical reactions and results in decomposition of electrolyte. Thus, it is evident that conventional FEC use makes the electrolyte chemically unstable, and negatively impacts cell performance. It is particularly desirable to reduce the amount of FEC for applications requiring long cycle life, such as electric vehicles (EV).

The development of electrolyte formulations providing excellent cycling performance, especially long cycle life for electric vehicle applications, is a key factor in the successful development of high energy density cells utilizing a platform of Ni-rich NCM cathode and Si material applied anode.

### Aspects of the Technical Solution

Embodiments in accordance with the present disclosure provide an electrolyte, electrolyte formulation, or electrolyte composition for lithium secondary batteries, and which provides excellent cycle life as well as high temperature stability with cell chemistries employing (a) high-Ni NCM cathode, and (b) anode containing or blended with silicon and artificial or natural graphite, even at high voltage charging. In addition to providing a lithium secondary battery electrolyte featuring long cycle life without reducing power capability, and featuring high temperature stability for a cell chemistry utilizing Ni-rich NCM cathode and Si material applied anode, embodiments in accordance with the present disclosure provide a lithium secondary battery including or comprising such electrolyte. Lithium secondary batteries in accordance with embodiments of the present disclosure are suitable for applications requiring high energy density, long cycle life, high power and high temperature stability, including applications such as EV, PHEV, HEV, and electric bikes in addition to consumer electronics.

Various embodiments in accordance with the present disclosure are directed to an electrolyte composition including or providing a combined platform of additives, or more particularly, certain types of additives employed in combination, e.g., in selected proportions, for lithium secondary batteries having high energy density and based on cell chemistry of Ni-rich NCM cathode and anode blended with silicon and artificial or natural graphite. Still more particularly, a new electrolyte composition offers a promising solution for improving the performance of Si material based applied cells. Such a new electrolyte composition produces a robust and stable organic/inorganic SEI, very favorably impacting the performance of Si anode applied cells by way of focusing on (i) extending cycle life, e.g., to provide long cycle life; (ii) suppressing resistance increase; and (iii) improving high temperature stability. Novel electrolyte compositions in accordance with embodiments of the present disclosure provide for or establish a multi-step SEI formation by way of particular unique multi-component additive combinations, e.g., particular additives in certain unique proportions. This specialized SEI formation provided by embodiments in accordance with the present disclosure for Si anodes can slow down the rate of electrolyte decomposition and recover the damaged SEI layer caused by Si material properties at the proper rate of electrolyte reaction.

Lithium secondary battery cells of high energy density which include or employ a lithium secondary battery electrolyte composition in accordance with various embodiments of the present disclosure have excellent cycle life without increasing resistance, while well-maintaining fundamental or basic performance measures or metrics such as initial capacity, power characteristic and rate capability by way of adopting a lithium secondary battery electrolyte solution in accordance with the present disclosure, which contains a combined system of multiple additives. In addition, such lithium secondary battery cells have improvement in high temperature stability, showing suppression of increased rate of Direct Current Internal Resistance (DCIR) and good capacity recovery at high temperature.

Electrolyte formulations in accordance with embodiments of the present disclosure include a cathode additive for Ni-rich NCM cathodes, as well as multiple additives for anodes blended with silicon in the form of SiOx or silicon carbon nanocomposite (SCN) and graphite with respect to producing a stable and robust organic and inorganic SEI film on the anode.

In various embodiments, vinyl carbonate (VC) having structure (a) below is included at 0.5 to 5% by weight based on the total weight of the electrolyte, and in several embodiments more preferably at 1 to 3% by weight.

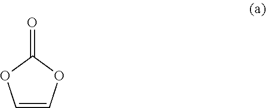

Also, fluoroethylene carbonate (FEC) having structure (b) below is included at 1 to 10% by weight based on the total weight of the electrolyte, and in several embodiments more preferably at 3 to 8% by weight.

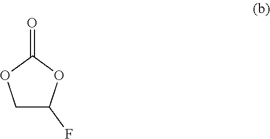

Vinyl carbonate (VC) and fluoroethylene carbonate (FEC) undergo reductive reaction to form protective SEI films mainly on the surface of the anode.

Furthermore, a lithium salt compound having chemical formula (1) below and which can exist in structural forms (c) through (f) below, is included as an additive. More particularly, in various embodiments lithium difluorobis(oxalato)phosphate (LiDFBP) having structure (d) below is included as an additive at 0.5 to 5% by weight based on the total weight of the electrolyte, and in multiple embodiments more preferably at 0.5 to 3% by weight.

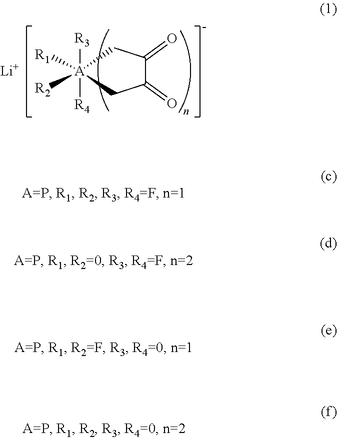

The lithium salt compound is utilized as a reducible additive for the anode to form a SEI. Similar compounds (which could additionally or alternatively be used in certain embodiments) include lithium bis(oxalato)borate (LiBOB), lithium tetrafluoro(oxalato)phosphate (LiTFOP) and lithium difluoro(oxalato)borate (LiDFOB); however, in various embodiments in accordance with the present disclosure, lithium difluoro bis(oxalato)phosphate (LiDFBP) is used.

The molecular structure of LiDFBP contains two oxalates and two fluorine atoms bonded to a central phosphorous core. The LiDFBP-derived SEI improves Li-ion transport significantly lowering cell resistance, and effectively prevent the formation of byproducts that are generated from the decomposition of the electrolyte during cycling. The use of LiDFBP in combination with or the incorporation of LiDFBP into the FEC and VC additives results in excellent cycling performance of artificial or natural graphite/SCN negative electrodes. This improvement originates from the generation of a thinner and better quality SEI film, with little LiF by the sacrificial reduction of the LiDFBP additive on the anode of the blended material.

Further to the foregoing additives, a nitrile-containing additive such as adiponitrile (ADN), which has chemical formula (2) below and which exists in structural form (i) below, is included. More particularly, in several embodiments ADN is included at 0.3 to 3% by weight based on the total weight of the electrolyte, and in several embodiments more preferably at 0.3 to 2% by weight.

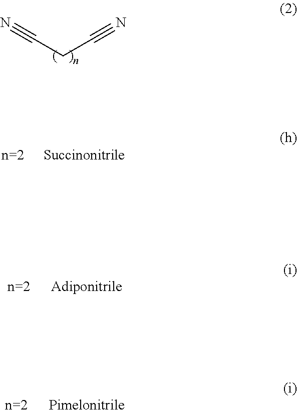

The adiponitrile (ADN) stabilizes the cathode surface by coordination with the transition metal of the cathode, and further with the structure of cathode as well. This coordinative interaction diminishes side reactions between the electrolyte and cathode surface at normal or even high temperatures (e.g., approximately 20-60° C. on a sustained basis, or possibly up to approximately 130° C. over a short duration such as 30-60 minutes, for instance, in a special situation or under special conditions such as safety evaluation based on a heat box test), which decreases gas generation, which decreases gas generation. Such ADN-related cathode stabilization provides improvement in cycling performance, and lowers the rate of increase in internal resistance, as further considered below. It can be noted that an electrolyte formulation or composition in accordance with an embodiment of the present disclosure which includes AND exhibits better thermal stability than an alternate embodiment that lacks AND (e.g., in terms of bulging and operational failure rate).

It can be noted that the use of these types of nitrile-containing additives, having a nitrile group as a core functional group in their molecular structure, has been avoided in applications requiring high power performance, because they typically increase internal resistance. However, the application of such nitrile-type additives and particularly ADN in combination with other additives set forth herein in accordance with embodiments of the present disclosure shows excellent cell performance, including improved cycle life and high temperature stability without fading power capability.

### EXAMPLES/EXPERIMENTAL TESTS AND RESULTS

Li Ion Secondary Battery Fabrication

Representative example lithium ion secondary batteries implemented in accordance with embodiments of the present disclosure, as well as representative control lithium ion secondary batteries, were produced, which included a cathode, anode, and separator disposed between two electrodes (i.e., a cathode electrode and an anode electrode) in order to prevent a short circuit. Then, electrolytes were injected into particular cells accordingly, including electrolytes in accordance with embodiments of the present disclosure as well as a commercially-available control electrolyte. The representative example lithium ion secondary batteries and the representative control lithium ion secondary batteries were produced in pouch type form, but are not limited to this single form type. In addition to the pouch type form, cylindrical, prismatic, or polymer pouch cells can be produced, as individuals having ordinary skill in the relevant art will readily understand.

In the representative example and the control lithium ion secondary batteries, Ni-rich NCM, i.e., LiNi_{0.8}Co_{0.1}Mn_{0.1}O₂, was used as a positive electrode active material, and polyvinylidene difluoride (PVdF) is used as a binder and super-p as a conductive agent, in a manner that individuals having ordinary skill in the art will readily comprehend. A slurry of positive electrode active material was prepared by mixing and dispersing a positive electrode active material, binder and conductive agent in a specific weight ratio in N-methyl-2-pyrrolidone (NMP). The positive electrode active material slurry was coated on an aluminum foil having a thickness of 12 micrometers (μm), dried, and rolled to prepare a positive electrode, as individuals having ordinary skill in the relevant art will also comprehend. Synthetic (or artificial) graphite and silicon carbon nanocomposite (SCN) were blended for a negative electrode active material in a ratio of 85:15, which was dispersed with styrene-butadiene rubber (SBR) as a binder and carboxymethyl cellulose (CMC) as a thickener in a specific weight ratio in water to prepare a slurry of negative electrode active material. The negative electrode active material slurry was coated on a copper foil having a thickness of 8 μm; dried; and rolled to prepare a negative electrode.

The control lithium ion secondary batteries were identical to the representative example lithium ion secondary batteries, and were prepared in the same manner as the representative example lithium ion secondary batteries, with the exception of the electrolyte used in the control lithium ion secondary batteries. More specifically, the control lithium ion secondary batteries utilized electrolytes available from a commercial electrolyte manufacturer, as further elaborated upon below.

A 20 μm thick ceramic coated polyethylene (PE) separator was stacked between the prepared electrodes to form cells of 2.1 Ah, 3 Ah, 48 Ah and 60 Ah. Lithium ion secondary batteries were finally prepared by injecting non-aqueous electrolyte, in a manner that individuals having ordinary skill in the relevant art will readily comprehend.

Electrolyte Preparation Electrolyte compositions or formulations (which can simply be referred to as electrolytes) for the representative examples considered herein included a lithium salt and a solvent blend. The lithium salt was LiPF₆, and was used at a concentration of 1.15M. With respect to the solvent blend, the formulations typically contained ethylene carbonate (EC), ethyl methyl carbonate (EMC). dimethyl carbonate (DMC) in the ratio of EC/EMC/DMC at 30/40/30 by volume. The electrolytes in accordance with embodiments of the present disclosure included a combination of the additives Vinylene Carbonate (VC), Fluoroethylene Carbonate (FEC), Lithium Difluorobis(oxalato)phosphate (LiDFBP) and Adiponitrile (ADN), in amounts set forth above.

More particularly, based on the total weight of the electrolyte composition:
the lithium difluorobis(oxalato)phosphate (LiDFBP) was included at 0.5 to 3% by weight;
the vinyl carbonate (VC) was included at 1 to 3% by weight;
the fluoroethylene carbonate (FEC) was included at 3 to 8% by weight; and
the adiponitrile (ADN) was included at 0.3 to 2% by weight.

With respect to the particular results provided below, the representative example electrolytes are designated as “UE-064”, which utilized a multi-additive formulation or composition in which LiDFBP was present at 1%, VC was present at 1.5%, FEC was present at 5%, and ADN was present at 0.7% by weight based on the total weight of the UE-064 electrolyte composition.

Additionally, the control electrolytes are designated as “Ctrl ELY” or “Control ELY.” Control electrolytes were provided by a commercial electrolyte vendor (Dongwha Electrolyte, Nonsan Korea/Tianjin China, www.dongwhaelectrolyte.com). The control electrolyte formulations were based on EC/EMC/DMC in a ratio of 2/2/46/4.54, with 1.1M LiPF₆. The control electrolytes also included additives, e.g., 1.5% VC, 1% Boron based additive, and 0.5% Sulfur based additive.

Evaluation Results

The 2.1, 2.5, 48 and 60 Ah cells were prepared and evaluated in terms of nominal capacity, cycle life, DCR, rate capability, increase rate of DCIR, and capacity recovery for high temperature storage.

The SEI formed by an electrolyte may act as a barrier for lithium ion transport, adversely affecting capacity. As indicated in Table 1 below, electrolyte formulations in accordance with embodiments of the present disclosure show equivalent or slightly higher capacities and nominal voltages to the control electrolyte. In Table 1 as well as multiple FIGs. and corresponding portions of the description below, control electrolytes are designated “Ctrl ELY” or “Control ELY,” and electrolytes in accordance with an embodiment of the present disclosure are designated as “UE-064.”

TABLE 1
Discharge Capacities at C/3 of 2.1 Ah Pouch Cells

| ELY | Device # | Capacity @C/3 (Ah) | Nominal V (V) |
|---|---|---|---|
| Ctrl ELY | D00141 | 2.081 | 3.64 |
| Ctrl ELY | D00142 | 2.081 | 3.64 |
| Ctrl ELY | D00143 | 2.084 | 3.64 |
| Ctrl ELY | D00180 | 2.102 | 3.65 |
| Ctrl ELY | D00181 | 2.094 | 3.65 |
| Ctrl ELY | D00182 | 2.096 | 3.66 |
| UE-064 | D00177 | 2.111 | 3.66 |
| UE-064 | D00178 | 2.114 | 3.66 |
| UE-064 | D00179 | 2.117 | 3.66 |
| UE-064 | D00282 | 2.117 | 3.67 |
| UE-064 | D00283 | 2.105 | 3.67 |
| UE-064 | D00284 | 2.092 | 3.66 |

Capacity retention is used for the evaluation of cycling performance at room temperature. The exact testing condition for cycle life is 1C rate CCCV charge/1C rate CC discharge and 4.2V-2.8V operating voltage, in a manner that individuals having ordinary skill in the relevant art will understand. The capacity retention is calculated as:

Capacity Retention (%)=(final capacity/initial capacity)×100(%)

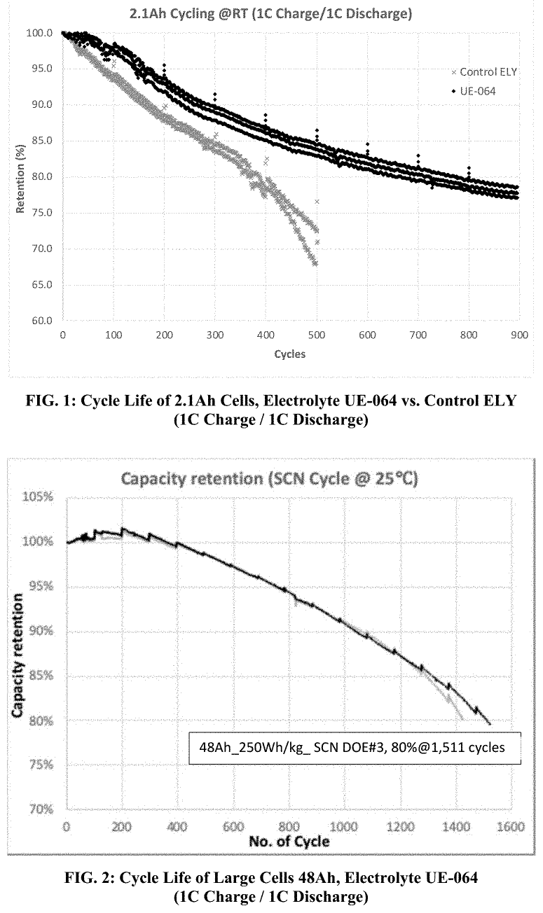

Lithium secondary battery electrolyte formulations (UE-064) in accordance with embodiments of the present disclosure exhibit a remarkably improved cycling performance by way of the combination of unique additives, specifically the nitrile additive for Ni-rich NCM cathode, plus a combination of three other additives set forth herein for anodes blended with artificial graphite and silicon carbon nanocomposite (Gr:SCN=85:15). The cycling test with 2.1 Ah pouch cells as shown in FIG. 1 demonstrated that the cycle life of lithium ion secondary batteries including electrolyte formulations (UE-064) in accordance with embodiments of the present disclosure achieved nearly double the cycle life of the control lithium ion secondary batteries using the control electrolyte (Control-ELY). The End of Life (EOL) provided in association with electrolyte formulations (UE-064) in accordance with embodiments of the present disclosure exhibited 80% capacity retention at 775 cycles, whereas the EOL provided in association with the control electrolyte (Control ELY) exhibited 80% capacity retention at 380 cycles. It is quite noteworthy that the cycling of the control electrolyte (Control ELY) crashed at EOL, but the cycling of representative example electrolytes (UE-064) in accordance with embodiments of the present disclosure did not crash even after EOL, maintaining a stable slope.

The cycle life of the large cell EV 48 Ah using electrolyte formulations (UE-064) in accordance with embodiments of the present disclosure, achieved 80% capacity retention at 1,511 cycles as shown in FIG. 2, which was a surprisingly good result.

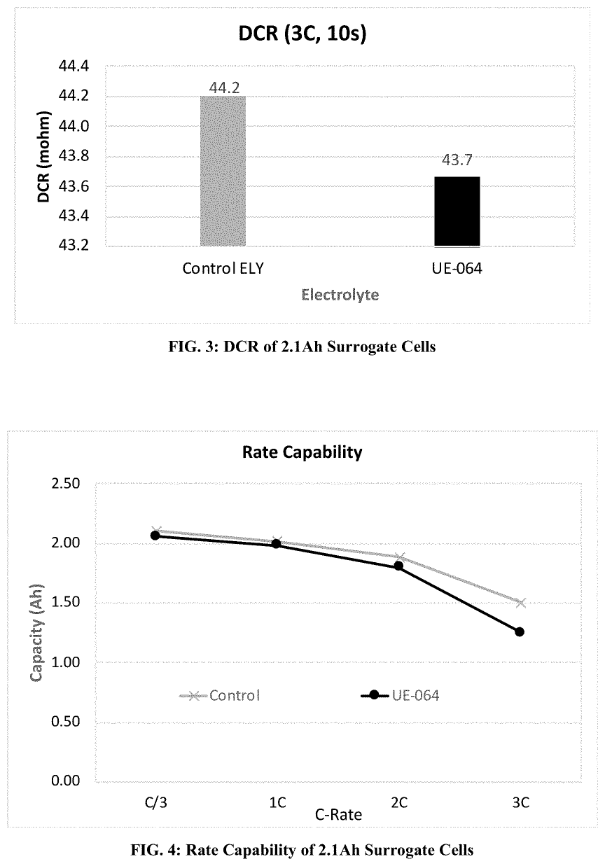

As shown in FIGS. 3 and 4, and Table 2 below, representative example lithium ion secondary batteries using electrolytes (UE-064) in accordance with embodiments of the present disclosure exhibit lower DCIR and equivalent rate capability compared to control lithium ion secondary batteries using the control electrolyte (Control ELY/Ctrl ELY). These results are unexpected given that the representative electrolytes in accordance with embodiments of the present disclosure (UE-064) contain more additives in terms of both kind and content compared to the control electrolyte (Control ELY).

TABLE 2
Rate Capacities of 2.1 Ah Surrogate Cells

| | C/3(Ah) | 1 C(Ah) | 2 C(Ah) | 3 C(Ah) |
|---|---|---|---|---|
| Ctrl ELY | 2.101 | 2.015 | 1.881 | 1.505 |
| UE-064 | 2.054 | 1.981 | 1.799 | 1.251 |

Evaluation of High Temperature Storage Performance

The vigorous side reactions between cathode and electrolyte, which particularly occur by way of the nickel species from Ni-rich NCM producing gas products, lead to cell bulging, capacity loss, and growing internal resistance. The elution of metal component(s) from the cathode is taken into account as a critical factor deteriorating the cell performance. The metal dissolution results in capacity attenuation and the transition metal components in the electrolyte were electrodeposited on the anode surface(s) to catalyze electrolyte reduction. Furthermore, the cell chemistry of Ni-rich NCM cathode and silicon blended graphite anode for high energy density undergoes more serious problems at high temperatures (for instance, which typically ranges from 45-60° C., e.g., where high temperature cycling is typically implemented at approximately 45° C., and high temperature storage is evaluated at between approximately 55-60° C.).

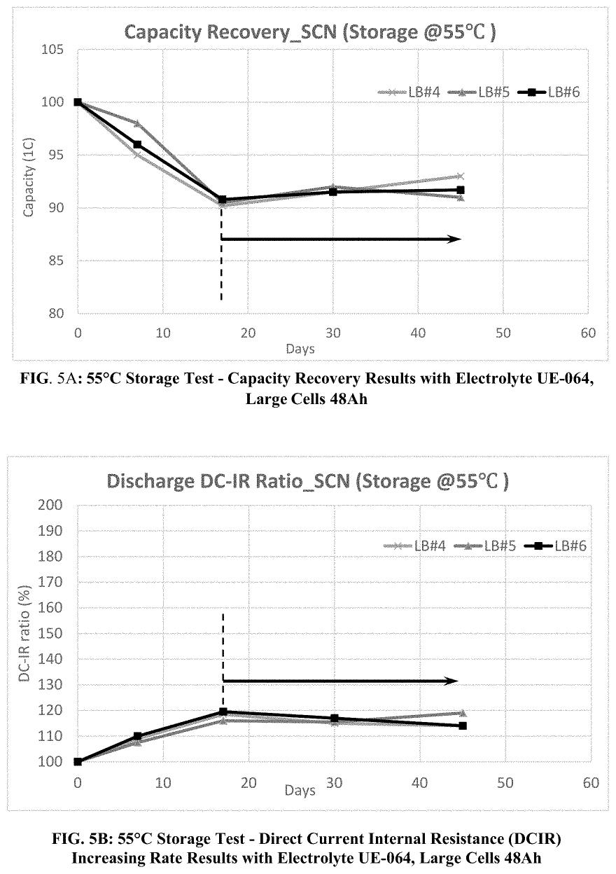

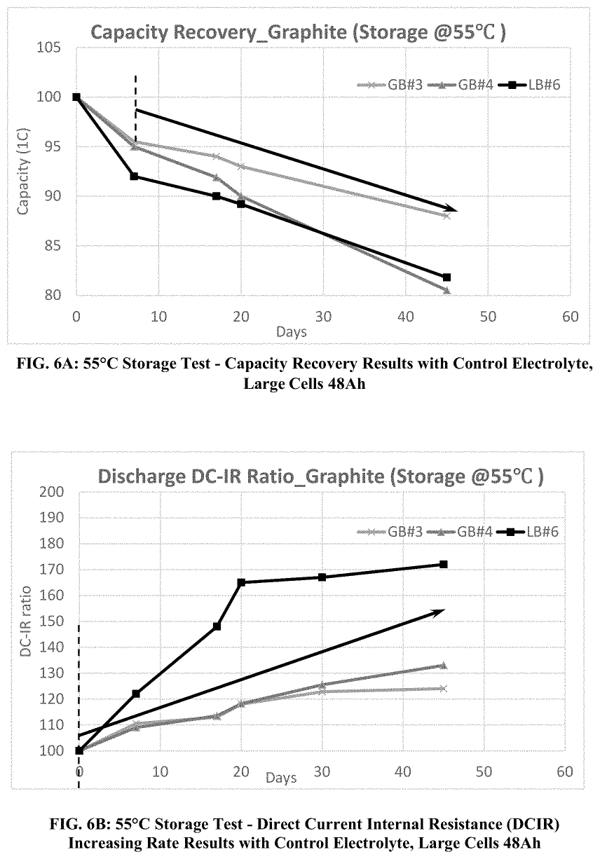

In order to address the issue of high temperature stability, the representative lithium ion secondary batteries having electrolyte formulations (UE-064) in accordance with embodiments of the present disclosure and the representative lithium ion secondary batteries having the control electrolyte formulation (Control-ELY) were evaluated in a high temperature storage test. The results of a large cell storage test at 55° C. are shown in FIGS. 5A-5B and 6A-6B. The control electrolyte (Control-ELY) and the electrolytes (UE-064) in accordance with embodiments of the present disclosure were compared in the large cell storage test. The control cell (having an anode of artificial graphite) using the control electrolyte (Control-ELY) kept losing capacity and exhibited increasing DCIR over time. However, the representative example cell (anode blended with artificial graphite and silicon carbon nanocomposite) using electrolytes (UE-064) in accordance with embodiments of the present disclosure showed a recovery capacity that dropped to 90% after two weeks, and maintained the capacity without capacity decay. The increase rate of DCIR was also maintained after two weeks. Therefore, electrolyte formulations in accordance with embodiments of the present disclosure exhibit improved high temperature stability.

Electrolytes in accordance with embodiments of the present disclosure include an additive having a nitrile functional group, specifically adiponitrile in various embodiments. The adiponitrile stabilizes the cathode surface by the coordination between the nitrile group and the cathode material. Furthermore, the cathode structure is stabilized by coordinative interaction as well. With respect to the cathode additive, adiponitrile not only suppresses gas generation at room temperature or even high(er) temperatures, lowering cell thickness, and also prevents capacity decay and increase in DCIR. Such results can be noted in cells that have gone through a high temperature storage test, e.g., between approximately 55-60° C., and which have possibly furthermore been subjected to a temperature of approximately 130° C. in association with a heat box test. It can be noted that cells including nitrile functionality (e.g., provided by ADN) are more likely to pass a heat box test than cells lacking nitrile functionality.

The high temperature stability testing was performed at 100% state of charge (SOC100). The representative example anode blended with silicon and graphite maintain high concentration of lithium. As a result, this anode is very reactive to electrolyte at high temperature. It is believed that the stable and robust organic and inorganic SEI formed on the anode by the unique multicomponent additive combination in accordance with electrolyte embodiments of the present disclosure plays a significant role to improve high temperature stability by minimizing the increase rate of DCIR and providing excellent capacity recovery, as indicated in FIGS. 5A and 5B. An electrolyte in accordance with an embodiment of the present disclosure (e.g., UE-064) can establish a well-balanced cell platform by forming a stable SEI film on both cathode and anode.

Additional Experimental Characterization

Beyond the foregoing, electrochemical impedance spectroscopy of lithium ion secondary cells containing different types of electrolyte additives was performed for purpose of comparing the electrochemical impedance spectroscopy behavior of certain individual electrolyte additives against the electrochemical impedance spectroscopy behavior of an additive combination in accordance with an embodiment of the present disclosure (UE-064).

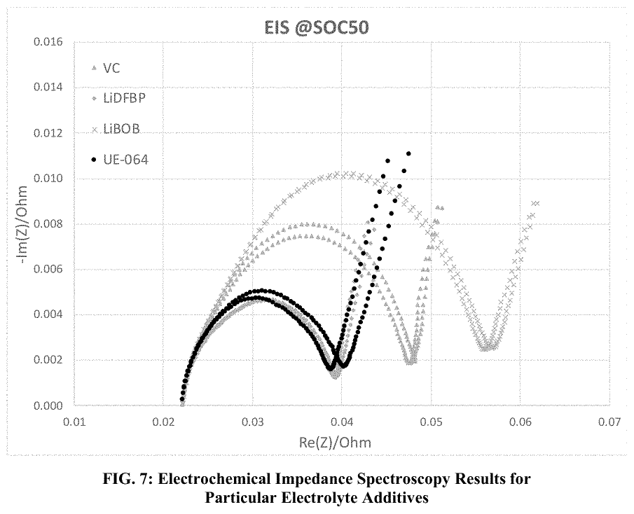

Individuals having ordinary skill in the relevant art will understand that while the SEI layer formed by way of electrolyte components protects the electrode surface(s), it causes a rise in resistance for the transport of lithium ions. As shown in electrochemical impedance spectroscopy results of FIG. 7, by itself VC, which has structure (a) above, has a certain level of resistance, which is considered considerably or undesirably high. Additionally, by itself lithium salt compound lithium bis(oxalato)borate (LiBOB) having structure (f) above (i.e., LiBOB alone) is well known for suppressing the rate of increase of internal resistance, but shows higher resistance than VC alone at an initial or particular point (5^{th} cycle). Lithium salt compound LiDFBP, which has structure (d) above, exhibits a relatively smaller impedance compared to VC alone and LiBOB alone, corresponding to expected better ionic mobility. As further indicated in FIG. 7, electrolytes in accordance with embodiments of the present disclosure (e.g., UE-064), which include a combination of four additives, namely, each of VC, FEC, LiDFBP, and ADN, surprisingly exhibit an impedance that is very similar or approximately equivalent to that of the single additive LiDFBP by itself, even though electrolytes in accordance with embodiments of the present disclosure contain multiple additives. Particular performance characteristics of lithium ion secondary cells using LiDFBP alone, such as power capability and cycle life, can thus provide a general guide for at least some performance characteristics of lithium ion secondary cells containing electrolytes in accordance with embodiments of the present disclosure.

### CONCLUSIONS

Lithium ion secondary batteries employing a secondary battery electrolyte containing a combination of specific additives in accordance with embodiments of the present disclosure have excellent long cycle life and high temperature stability, as shown in the results of increase rate of internal resistance and capacity recovery at 55° C., in particular for the cell chemistry of Ni-rich NCM (more than 70% Ni content) cathode and anode blended with Si and graphite (1˜7% Si content). It can be determined that for combinations of key additives, the cathode additive plays a significant role for the Ni-rich NCM, and the combined system of unique additives produces stable and robust organic and inorganic SEI which is composed of multiple components, which improves the surface stability of anodes that include silicon materials.

A proposed or likely working mechanism of the cathode additive ADN with respect to the cathode material can be described as follows. First, the nitrile additive improves cycle life and high temperature stability by reacting with water and HF. The nitrile functional group can react with water in acidic conditions as shown below in Reaction Scheme 1, then water content drops down, which relieves the process of lithium hexafluorophosphate (LiPF₆) decomposition into HF. It is also able to reduce the side reaction due to the formation of an electrochemical active intermediate, an amide (RCONH₂) which experiences secondary reaction under electrochemical condition to modify SEI components.

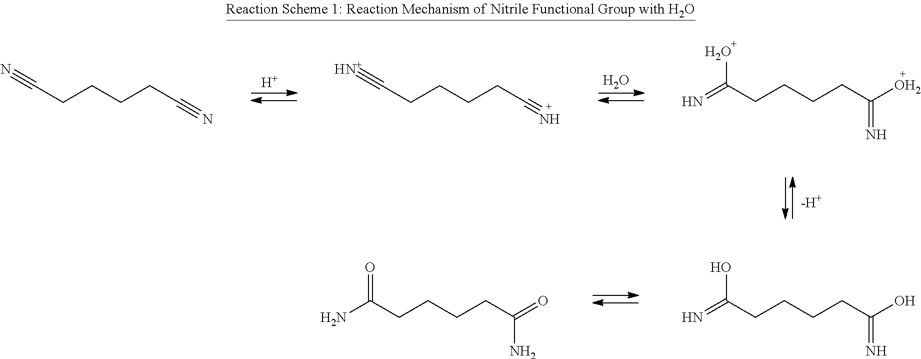

Second, coordination of the additive functional group to the cathode protects cathode surface(s) and reduces side reactions by avoiding direct contact between the electrolyte and cathode surface(s). With respect to some functionalities, the nitrile functional group of the present invention, with non-pair of electrons or π-bond, have strong interaction with the cathode through metal-ligand complex to stabilize and protect the cathode surface from decomposition by HF or H₂O and further stabilize and protect the structure of cathode. The interaction between transition metals and additives can be taken into account by way of σ-bonding/n-backbonding. In a system of σ-donor/n-acceptor, the chemisorption of the functional group of an additive on metal is understood as σ-donation from the lone pair of electrons of the functional group to the d orbital of the metal and π-backbonding from the d orbital of the metal to π* orbital of the functional group. This model of σ-donor/π-acceptor can be expanded to various functional groups such as phosphine, carbene ligand, and so on, as will be understood by individuals having ordinary skill in the relevant art. This type of additive creates a stable film on the transition metal of the cathode by way of σ-donation/π-backbonding, which suppresses side reactions between the electrolyte and the cathode and benefits thermal stability on the electrode surface(s). This chemisorption has been confirmed by XPS (X-ray Photoelectron Spectroscopy). The coordination of additives through their functional group to transition metal makes the corresponding binding energy shift to more positive values. The stable film(s) formed on cathode surface(s) through coordination of the additive functional group to cathode improves cell performance by suppressing parasitic electrolyte—cathode reactions by avoiding direct contact between the electrolyte and cathode.

An effective charge balancing mechanism can explain the occurrence of the preferential chemisorption of the nitrile functional group on the surface of transition metal oxide. The additive molecules in the electrolyte coordinated to the surface of the cathode are electron-rich, contributing electronegative environments (δ−) to surface atoms of the cathode transition metal. Such electrons of the additives are not completely taken away by the transition metal of the cathode; they still belong to the additives. During the process of charging, more electrons are extracted from the surface of cathode to form the complex cathode-additives. The resulting positive charge density (δ+) for the surface is unequal to the charge density (δ++) of the bulk before lithium ions escape from the cathode material, since their effective charge is more negative than that of transition metal in bulk. After the oxidation process, an equilibrated charged state is established. More particularly, the transition metal in the surface have larger oxidation numbers that are compensated by the electronegative cloud of ADN (δ−). Then it can be equal to the charge state of the bulk.

As the lithium secondary battery is repeatedly charged and discharged, the cathode active material is structurally collapsed and metal ions are eluted from the surface of the cathode. The dissolved metal ions are electrodeposited on the cathode, which deteriorates the cathode. This deterioration phenomenon tends to be accelerated when the potential of the positive electrode is increased by overpotential or when the cell is exposed to high temperature. In addition, when the operational upper voltage is increased, the lithium secondary battery may cause film decomposition on the surface of the positive electrode, and the surface of the positive electrode may be exposed to the electrolyte, causing problems such as side reaction with the electrolyte. The transition metal (i.e., Mn, Ni, and Co) ions that dissolve from the cathode can move toward a lithiated anode. Consequently, metal deposition can occur on the anode surface. Deposition of such metal ions leads to the removal of electrons from the fully lithiated anode. This electron consumption via metal reduction results in the extraction of Li ions from the anode, which causes an increase in the anode potential and capacity loss with the limited Li⁺ source.

The use of lithium difluorobis(oxalate)phosphate (LiDFBP), structure (d) above, in the lithium secondary battery electrolyte in accordance with various embodiments of the present disclosure, is very notable. LiDFBP is reduced at 1.7 V vs Li⁺/Li, and forms an artificial and stable solid electrolyte interface (SEI) layer that can improve the capacity retention of the lithium secondary battery. The LiDFBP is activated through electron transfer reaction to produce an opened oxalato group, which undergoes a polymerization reaction and forms a protective film or layer on the surface of the anode. However, the artificial protecting layer by types of oxalate- and/or fluoride containing additives increases the surface impedance, lowering power capability. Exceptionally and surprisingly, the use, addition, or presence of LiDFBP in additive combinations in accordance with embodiments of the present disclosure gives rise to low impedance, and the impedance increase rate is much lower than expected as well. It is believed that the combination of LiDFBP with the other additives, in particular FEC and VC, in accordance with embodiments of the present disclosure, modifies SEI layers and produces a more or much more stable and robust film. This efficiently suppresses the side reactions and slows down impedance growth. The addition of LiDFBP is beneficial to long term power retention and long cycling performance. The LiDFBP-derived SEI has sufficient ionic permeability as well as enough electrochemical robustness to prevent irreversible electrolyte decomposition that would cause capacity decay upon repeated charge and discharge processes. The use of LiDFBP in electrolyte additive combinations in accordance with embodiments of the present disclosure drastically improves cycling performance when using an SCN-graphite anode. The excellent rate capability of the SCN-graphite anode may be at least partially ascribed to the LiDFBP-derived SEI that may facilitate Li-ion transport at the anode-electrolyte interface.

1. A lithium ion secondary battery electrolyte composition, comprising:
a lithium salt;
at least one organic solvent; and
a plurality of additives, comprising:
vinylene carbonate (VC) having structure (i): 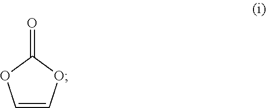
fluoroethylene carbonate (FEC) having structure (ii): 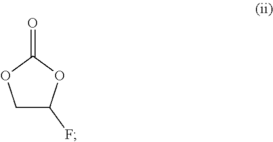
lithium diflurobis(oxalate)phosphate (LiDFBP) having chemical formula (1) and structure (iii): 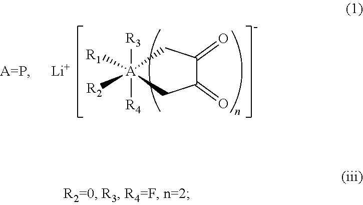
and
adiponitrile (ADN) having chemical formula (2) and structure (iv): 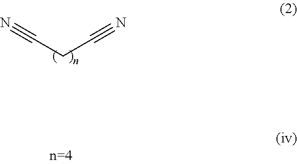
in combination.

2. The electrolyte composition of claim 1, wherein the VC is present at 0.5 to 5% by weight based on total weight of the electrolyte composition.

3. The electrolyte composition of claim 2, wherein the VC is present at 1 to 3% by weight based on total weight of the electrolyte composition.

4. The electrolyte composition of claim 1, wherein the FEC is present at 1 to 10% by weight based on total weight of the electrolyte composition.

5. The electrolyte composition of claim 4, wherein the FEC is present at 3 to 8% by weight based on total weight of the electrolyte composition.

6. The electrolyte composition of claim 1, wherein the LiDFBP is present at 0.5 to 5% by weight based on total weight of the electrolyte composition.

7. The electrolyte composition of claim 6, wherein the LiDFBP is present at 0.5 to 3% by weight based on total weight of the electrolyte composition.

8. The electrolyte composition of claim 1, wherein the ADN is present at 0.3 to 3% by weight based on total weight of the electrolyte composition.

9. The electrolyte composition of claim 1, wherein the ADN is present at 0.3 to 2% by weight based on total weight of the electrolyte composition.

10. A lithium ion secondary battery comprising:
a positive electrode having an active cathode material including a nickel-cobalt-manganese composition;
a negative electrode having an active anode material including silicon and graphite;
a separator interposed between the positive electrode and the negative electrode; and
the electrolyte composition of claim 1.

11. The lithium ion secondary battery of claim 10, wherein the nickel-cobalt-manganese composition is Li(Niₐ Co_{b} Mn_{c})O₂, wherein 0.7<a<0.95, 0.025<b<0.15, 0.025<c<0.15, and a+b+c=1.

12. The lithium ion secondary battery of claim 10, wherein the active anode material comprises artificial graphite blended with silicon in the form of silicon oxide (SiOx) or silicon carbon nanocomposite (SCN).

13. The lithium ion secondary battery of claim 12, wherein the pure silicon content of the SiOx or the SCN falls in a range of 1≤Si≤7%.
